(19) United States
(12) Patent Application Publication
(10) Pub. No.: US 2026/0297463 A1
(43) Pub. Date: Oct. 1, 2026

(54) CLEANING COMPOSITION

(71) Applicant: 3M INNOVATIVE PROPERTIES COMPANY, Saint Paul, MN (US)

(72) Inventors: Yinshi Jin, Hwaseong-si (KR); Yifan Zhang, Woodbury, MN (US); Petra L. Kohler Riedi, Minneapolis, MN (US); Shu Wei Zhang, Shanghai (CN); Masahiro Ashizawa, Saqamihara (JP); Tzu Chen Fu, New TaipeI City (TW)

(21) Appl. No.: 19/477,570

(22) PCT Filed: Apr. 25, 2023
(86) PCT No.: PCT/CN2023/090567

§ 371 Date: Oct. 22, 2025

(51) Int. Cl. C11D 3/48; A01N 25/30; A01N 37/04; A01P 1/00; C11D 1/14; C11D 1/22; C11D 1/37; C11D 3/20; C11D 3/30; C11D 3/33; C11D 3/37; C11D 17/04

(52) U.S. Cl. CPC C11D 3/48; A01N 25/30; A01N 37/04; A01P 1/00; C11D 1/37; C11D 3/2044; C11D 3/2065; C11D 3/2068; C11D 3/2079; C11D 3/2086; C11D 3/30; C11D 3/33; C11D 3/3765; C11D 3/3776; C11D 17/049; C11D 1/146; C11D 1/22

(57) ABSTRACT

Provided is an antimicrobial cleaning composition that includes an anionic surfactant, which optionally comprises a sulfate-based surfactant, sulfonate-based surfactant, or combination thereof. The composition further comprises sodium benzoate, optionally at least one of caprylyl glycol and ethylhexylglycerin, an acrylic-based copolymer, an organic acid, optionally comprising citric acid, and ethylenediaminetetraacetic acid. The provided compositions can provide antimicrobial activity and anti-fouling properties over an extended period of time in toilet bowl applications.

### FIELD OF THE INVENTION

Provided are compositions suitable for use in cleaning hard surfaces, which may be capable of being disposed onto scrubbing substrates.

### BACKGROUND

Cleaning toilet bowl surfaces is widely viewed as an unpleasant household task for consumers, and while many consumers find this task bothersome and dirty, they also consider it necessary. Effectively killing germs and bacteria is a top need in major consumer markets. While certain disposable toilet bowl scrubber products can address technical needs in scrubbing power, hygiene, and ease to use, conventional cleaning products do not provide long-lasting and broadly effective disinfection in addressing this consumer expectation.

Provided is a novel formulation that provides anti-fouling properties to a hard surface for a long-lasting clean effect and disinfecting benefits to disposable toilet bowl products and other household applications where such properties are desirable.

### SUMMARY

Conventional multipurpose cleaning products contain polydimethylsiloxane as an anti-fouling agent with hydrophobic properties. Anti-fouling performance, however, can disappear after subsequent exposure of the cleaning products with water. While polydimethylsiloxane has traditionally been used as an anti-fouling agent, this component can have a negative impact on the foaming performance. Existing multi-purpose cleaning products contain sodium benzoate as a disinfectant, but this alone does not provide good kill efficacy in relatively short contact time. The provided cleaning compositions provide excellent antimicrobial kill efficiency and extended hydrophilic treatment duration for superior anti-fouling properties relative to conventional products.

In a first aspect, an antimicrobial cleaning composition is provided. The antimicrobial cleaning composition comprises: an anionic surfactant, optionally comprising a sulfate-based surfactant, sulfonate-based surfactant, or combination thereof; sodium benzoate; optionally at least one of caprylyl glycol and ethylhexylglycerin; an acrylic-based copolymer; an organic acid, optionally comprising citric acid; and ethylenediaminetetraacetic acid.

In a second aspect, a cleaning article is provided, comprising the antimicrobial cleaning composition disposed on a cleaning substrate.

In a third aspect, a method of cleaning a surface is provided, comprising the steps of: applying the antimicrobial cleaning composition to a cleaning substrate, and wiping the cleaning substrate along the surface.

### Definitions

As used herein:

“Substantially free” of a component can mean having less than 1 percent, less than 0.5 percent, less than 0.25 percent, less than 0.1 percent, less than 0.05 percent, or less than 0.01 percent by weight of the component.

### DETAILED DESCRIPTION

As used herein, the terms “preferred” and “preferably” refer to embodiments described herein that can afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises,” and variations thereof do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, vertical, and the like may be used herein and, if so, are from the perspective observed in the particular drawing. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described relating to the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention.

The present invention is a clear, non-tacky cleaning composition that provides biocidal activity upon contact with a surface as well as residual biocidal activity after contact. In a preferred form, the cleaning composition is a liquid composition, such as an aqueous composition. The cleaning composition can clean, coat, and protect a surface in both its wet and subsequently dried state.

In some embodiments, the antimicrobial cleaning composition can include an anionic surfactant, such as sulfate-based surfactant, sulfonate-based surfactant, or combination thereof. Generally, surfactants are chemical compounds widely used in cleaning products, personal care products, and many other industrial applications.

The anionic surfactant is preferably present in an amount suitable to provide a suitable detergent effect while significantly increasing viscosity of the cleaning composition. The cleaning composition can contain from 3 percent to 30 percent, from 6 percent to 20 percent, from 9 percent to 15 percent, or in some embodiments, less than, equal to, or greater than 3 percent, 4, 5, 6, 7, 8, 9, 10, 12, 15, 17, 20, 22, 25, 27, or 30 percent of sulfate-based surfactant relative to the overall weight of the cleaning composition.

Sulfate-based surfactants are characterized by the presence of a sulfate group (—SO₄) in their chemical structure. Sodium lauryl sulfate (SLS) is an example of a useful sulfate-based surfactant. It is known for its use in shampoos, toothpaste, and other personal care products. Sodium laureth sulfate (SLES) is a milder version of SLS and is also commonly found in personal care products. SLES is derived from coconut oil and is considered to be less irritating than SLS in the event of skin contact. It is also more soluble in water, which makes it easier to use in formulations. Ammonium lauryl sulfate (ALS) is a sulfate-based surfactant that is commonly used in personal care products such as shampoo, body wash, and facial cleansers. ALS is also used in industrial applications such as the production of foaming agents and emulsifiers. SLS, SLES, and ammonium lauryl sulfate are all strong detergents that can effectively remove dirt and oil from soiled surfaces.

Sodium cocoyl isethionate is a sulfate-based surfactant that is commonly used in personal care products such as shampoo, body wash, and facial cleansers. It is derived from coconut oil and is considered to be a mild surfactant that is gentle on the skin. SCI is also used in industrial applications such as the production of detergent and emulsifiers.

The anionic surfactant can also be sulfonate-based. Sulfonate-based surfactants are a class of surfactants that contain a sulfonic acid group (—SO₃H) attached to an organic molecule. Sulfonate-based surfactants include sodium dodecylbenzenesulfonate, alkyl sulfonates containing a sulfonic acid group attached to an alkyl chain, and linear alkylbenzene sulfonates.

Both sulfate-based and sulfonate-based surfactants can be highly water-soluble and can have excellent wetting and foaming properties. They are advantageous in the provided cleaning composition due to their excellent emulsifying and dispersing properties, which help to break down and remove soilage from surfaces, such as toilet bowl surfaces. These surfactants can be highly effective at reducing the surface tension of liquids, which allows them to penetrate and clean surfaces more effectively. Second, they are highly stable and compatible with a wide range of cleaning ingredients, including enzymes, bleaches, and chelating agents. Third, they are biodegradable and have low toxicity, making them an environmentally friendly choice for cleaning formulations.

In a preferred embodiment, the cleaning composition includes a sulfonate-based surfactant that comprises triethanolamine dodecylbenzene sulfonate. Incorporating triethanolamine dodecylbenzene sulfonate can be beneficial in extending the duration of hydrophilic surface treatment. It was discovered, for instance, that in compositions that contain only a sulfate-based surfactant, the surface hydrophilicity can be sustained over three rinses with tap water, but a combination of sulfate-based and sulfonate-based surfactants, surface hydrophilicity can be sustained over more than 20 rinses with tap water.

In some embodiments, triethanolamine dodecylbenzene sulfonate is present in an amount of from 3 percent to 24 percent, from 4 percent to 12 percent, from 6 percent to 9 percent, or in some embodiments, less than, equal to, or greater than 3 percent, 4, 5, 6, 7, 8, 9, 10, 11, 12, 15, 17, 20, 22, or 24 percent, relative to the overall weight of the cleaning composition.

Various anionic surfactants, both sulfate and sulfonate based, are sold under the trade designation MICOLIN by Miwon Specialty Chemical Co., Ltd., Anyang City, South Korea, as well as STEPANOL, BIO-SOFT and LATHANOL from Stepan Company, Northbrook, IL.

In some embodiments, the antimicrobial cleaning composition can include sodium benzoate. Sodium benzoate is a compound derived from benzoic acid. It is a white crystalline powder and is used in various cosmetic and pharmaceutical products. Sodium benzoate is a highly effective preservative that works by inhibiting the growth of microorganisms such as bacteria, yeasts, and molds. When combined with other antimicrobial agents, sodium benzoate can prevent growth and proliferation of harmful bacteria and other pathogens.

The sodium benzoate is preferably present in an amount suitable to enhance the antimicrobial effect of the cleaning composition. The cleaning composition can contain from 0.1 percent to 10 percent, from 0.2 percent to 5 percent, from 0.5 percent to 3 percent, or in some embodiments, less than, equal to, or greater than 0.1 percent, 0.2, 0.3, 0.4, 0.5, 0.6, 0.7, 0.8, 0.9, 1, 1.5, 2, 2.5, 3, 3.5, 4, 4.5, 5, 6, 7, 8, 9, or 10 percent of sodium benzoate relative to the overall weight of the cleaning composition.

As a further option, the antimicrobial cleaning composition can include one or both of caprylyl glycol and ethylhexylglycerin.

Caprylyl glycol is a clear, odorless liquid or wax that has both emollient and humectant properties, making it useful in formulations that require moisturizing and conditioning effects. One of the key benefits of caprylyl glycol is its ability to improve the stability of coating formulations. It works by enhancing the solubility and dispersibility of other ingredients in the formulation, which helps to prevent separation and clumping. While often found in products such as cosmetics, where a stable, consistent texture is important, these benefits of caprylyl glycol can also extend to cleaning compositions.

Caprylyl glycol is also valued for its ability to function as a natural preservative. It has antimicrobial properties that can help to inhibit the growth of bacteria, yeast, and fungi, which can extend the shelf life of the product and prevent contamination. Advantageously, caprylyl glycol has a low toxicity.

If present, caprylyl glycol is preferably present in an amount suitable to provide improved stability and texture in the provided cleaning composition. The cleaning composition can contain from 0.1 percent to 10 percent, from 0.5 percent to 5 percent, from 1 percent to 3 percent, or in some embodiments, less than, equal to, or greater than 0.1 percent, 0.2, 0.3, 0.4, 0.5, 0.7, 1, 1.1, 1.2, 1.5, 1.7, 2, 2.5, 3, 3.5, 4, 4.5, or 5 percent of caprylyl glycol relative to the overall weight of the cleaning composition.

Ethylhexylglycerin is a multifunctional ingredient commonly used in antimicrobial compositions due to its ability to provide a range of benefits. Its use in these compositions helps to inhibit the growth of microorganisms and provides additional advantages that make it an attractive ingredient for many applications. A primary benefit of ethylhexylglycerin is its ability to enhance the efficacy of other antimicrobial agents. This synergistic effect can make the overall antimicrobial composition more effective and efficient in controlling the growth of microorganisms. Ethylhexylglycerin can also function as a preservative and help prolong the shelf life of products.

If present, ethylhexylglycerin is preferably present in an amount suitable to enhance antimicrobial performance the provided cleaning composition. The cleaning composition can contain from 0.1 percent to 10 percent, from 0.5 percent to 5 percent, from 1 percent to 3 percent, or in some embodiments, less than, equal to, or greater than 0.1 percent, 0.2, 0.3, 0.4, 0.5, 0.7, 1, 1.1, 1.2, 1.5, 1.7, 2, 2.5, 3, 3.5, 4, 4.5, or 5 percent of ethylhexylglycerin relative to the overall weight of the cleaning composition.

The antimicrobial cleaning composition can include an acrylic-based copolymer. The acrylic-based copolymer is preferably hydrophilic and was discovered to provide significant anti-fouling properties when the composition is applied to a surface. Such properties can prevent microorganisms from re-attaching to a freshly cleaned surface. In a preferred embodiment, the acrylic-based copolymer is a copolymer of vinyl pyrrodine and dimethylaminoethyl methacrylate. In some embodiments, the acrylic-based copolymer includes a hydrophilic acrylic-based copolymer such as polyacrylamide acrylic acid.

Acrylic-based copolymers useful in the provided cleaning compositions are available under the trade designation MIRAPOL from Solvay, S.A., Neder-Over-Heembeek, Brussels, Belgium, MIHAPOL from Miwon Specialty Chemical Co., Ltd., and SOREZ from Ashland Global Specialty Chemicals Inc., Wilmington, DE.

One or more acrylic-based copolymers are preferably present in an amount suitable to impart anti-fouling properties on a substrate to which the cleaning composition is applied. The cleaning composition can contain from 1 percent to 25 percent, from 3 percent to 15 percent, from 5 percent to 10 percent, or in some embodiments, less than, equal to, or greater than 1 percent, 2, 3, 4, 5, 6, 7, 8, 9, 10, 11, 12, 13, 14, 15, 16, 17, 18, 19, 20, 21, 22, 23, 24, or 25 percent of acrylic-based copolymers relative to the overall weight of the cleaning composition.

The antimicrobial cleaning composition can include an organic acid, such as citric acid, formic acid, glycolic acid, or a combination thereof. One of the primary benefits of citric acid in an antimicrobial composition is its ability to inhibit the growth of microorganisms, including bacteria and fungi. Citric acid also has a chelating effect, which means it can bind to metal ions and prevent them from supporting the growth of microorganisms. Citric acid can also chelate divalent cations that stabilize cell envelopes of microorganisms. It was discovered that citric acid, in combination with caprylyl glycol and ethylhexylglycerin, can provide highly effective antibacterial properties with respect to both Gram (+) and Gram (−) bacteria. In preferred embodiments, this combination of components can enable at least a 99.99% kill efficacy with only a five-minute contact time.

In addition to its antimicrobial and preservative properties, citric acid can also function as a pH adjuster in formulations. It is a weak acid that can help to lower the pH of a product, which can be beneficial in improving cleaning efficacy for inorganic stains and inhibiting growth of certain microorganisms that prefer a more alkaline environment. Citric acid can also be a safe and environmentally friendly ingredient, making it a popular choice in many applications. It is also biodegradable and generally recognized as safe by regulatory agencies.

The citric acid is preferably present in an amount suitable to provide an adequate antimicrobial and chelating effect. The cleaning composition can contain from 0.1 percent to 10 percent, from 0.5 percent to 5 percent, from 1 percent to 3 percent, or in some embodiments, less than, equal to, or greater than 0.1 percent, 0.2, 0.3, 0.4, 0.5, 0.7, 1, 1.1, 1.2, 1.5, 1.7, 2, 2.5, 3, 3.5, 4, 4.5, or 5 percent of citric acid relative to the overall weight of the cleaning composition.

The antimicrobial cleaning composition can include ethylenediaminetetraacetic acid (EDTA). EDTA is a chelating agent commonly found in cleaning compositions because of its ability to bind to metal ions and improve the effectiveness of cleaning. Incorporating EDTA into a cleaning composition can provide numerous benefits.

First, EDTA is effective in removing hard water deposits such as calcium and magnesium ions, which can build up on surfaces and make cleaning more difficult. By chelating these metal ions, EDTA helps to break down the deposits and make them easier to remove. Second, EDTA can improve the cleaning ability of surfactants by sequestering metal ions that can interfere with their cleaning action. This allows the surfactants to work more effectively and produce better cleaning results. Third, EDTA can also help to prevent discoloration and corrosion on surfaces by binding to metal ions that can cause these issues. By chelating these metal ions, EDTA helps to keep surfaces looking clean and prevent damage resulting from metal ion buildup.

EDTA is a biodegradable compound and is considered to be environmentally friendly. It breaks down quickly in the environment and does not accumulate in living organisms, making it a safer and more sustainable option for cleaning compositions.

EDTA is preferably present in an amount suitable to provide a chelating effect in a household cleaning, and in particular toilet bowl scrubbing, applications. The cleaning composition can contain from 0.1 percent to 10 percent, from 0.5 percent to 8 percent, from 1 percent to 5 percent, or in some embodiments, less than, equal to, or greater than 0.1 percent, 0.2, 0.3, 0.4, 0.5, 0.7, 1, 1.2, 1.5, 1.7, 2, 2.5, 3, 3.5, 4, 4.5, 5, 6, 7, 8, 9, or 10 percent of EDTA relative to the overall weight of the cleaning composition.

Advantageously, the provided cleaning composition can display excellent antimicrobial activity without need for quaternary ammonium salts, such as alkyldimethylammonium chloride and alkyldimethyl benzyl ammonium chloride, which are found in other antimicrobial compositions. In preferred embodiments, the provided cleaning compositions are substantially free of any quaternary ammonium salts. Antimicrobial quaternary ammonium salts are typically micelle-forming surfactants. Undesirably, these compounds sometimes form mixed micelles with other surfactants and bind to anionic surfactants, rendering them unavailable as antimicrobials.

The balance of the provided cleaning compositions is generally comprised of water to obtain an aqueous composition with a suitable dispensing and handling properties. Water can be present in any appropriate amount, such as from 60 percent to 90 percent, from 65 percent to 85 percent, from 70 percent to 80 percent, or in some embodiments, less than, equal to, or greater than, 60 percent, 65, 70, 75, 80, 85, or 90 percent, relative to the overall weight of the cleaning composition.

In some embodiments, the composition is substantially free of siloxane components. Siloxanes are found in conventional cleaning compositions and can impart hydrophobic properties on surfaces to which it is applied, but often do not provide long-lasting anti-fouling properties after repeated rinsing. Polydimethylsiloxanes can also adversely impact foaming performance. Foaming is generally desirable in cleaning applications, since it can prolong contact time with a soiled surface and can also improve efficiency by reducing the overall amount of composition required to clean the surface.

Application of the cleaning composition can be conducted by manually applying it to a cleaning substrate, such as a toilet bowl scrubber, brush, or sponge, and then wiping the cleaning substrate against a surface to be cleaned. In some embodiments, the cleaning substrate is a made from a fibrous non-woven web. The fibrous non-woven web can be coated with the composition in an amount of from 10 percent to 25 percent by weight, relative to the overall weight of the coated fibrous non-woven web. While the provided compositions are especially useful for toilet bowl scrubbing applications, they can also be used for cleaning other household surfaces where sustained antimicrobial activity is desirable.

Advantageously, the disinfecting composition of the present invention has the ability to kill gram positive bacteria and gram negative bacteria. Generally, gram positive bacteria are monoderms and have a single lipid bilayer while gram negative bacteria are diderms and have two bilayers.

The disinfecting composition of the present invention forms a non-tacky film on a cleaned surface. That is, after drying, the disinfecting composition does not feel sticky to the touch. In one embodiment, the disinfecting composition is clear and non-visible to the eye upon application. Upon drying, the disinfecting composition of the present invention forms a substantially clear film, or at least a substantially translucent film.

The disinfecting composition is also wear-resistant. Upon drying, the coating clarity of the disinfecting composition is not substantially affected after being subjected to repeated rinses. In addition, the antimicrobial properties of the disinfecting composition were also substantially not affected by repeated rinses. In one embodiment, the disinfecting composition continues to kill bacteria for at least about 24 hours after application of the disinfecting composition, particularly for at least about 48 hours after application, and more particularly for at least about 72 hours after application.

Through shearing, the viscosity of the disinfecting solution can be tuned to allow for excellent coating capability of the composition either through, for example, metered coating applications or spray applications. The viscosity of the disinfecting solution is affected by choice of carboxylic acid, temperature of mixing, shear of blade stirring, and chemical additives such as hydrogen peroxide. In one embodiment, the disinfecting composition has a viscosity of about 50 cps, about 200 cps, or even about 300 cps. This provides a viscosity that can easily be dispensed from a common trigger spray system.

### Examples

Objects and advantages of this disclosure are further illustrated by the following non-limiting examples, but the particular materials and amounts thereof recited in these examples, as well as other conditions and details, should not be construed to unduly limit this disclosure. Unless otherwise noted, all parts, percentages, and ratios in the Examples and the rest of the specification are by weight. Where applicable, brand names and trademarked names are shown in all caps. Materials for preparing Examples and Comparative Examples described herein are listed in Table 1.

TABLE 1
Materials List

| Material | Description | Source |
|---|---|---|
| Blue Dye | Blue dye (1297-02), 40% | Wooshin Pigment Co., Ltd., |
| | | Seoul, South Korea |
| BTC 888 | Quaternary ammonium salt compound | Stepan Company |
| | (alkydimethylammonium chloride, | |
| | alkydimethyl benxyl ammonium | |
| | chloride), available under the | |
| | designation BTC 888, 100% | |
| CA | Citric acid anhydrous, 100% | Samchun Chemicals Co., Ltd., |
| | | Seoul, South Korea |
| CG | Caprylyl glycol, 1,2-Octanediol, 100% | ShinSeung Hichem Co., Ltd., |
| | | Seoul, South Korea |
| DCDC | Quaternary ammonium compound, | Lonza Ltd., Basel, Switzerland |
| | dicapryl/dicaprylyl dimonium chloride, | |
| | 80% | |
| EDTA-4Na | Ethylenediaminetetraacetic acid, | Nouryon Chemicals Ltd., |
| | tetrasodium salt, 85-90% | Amsterdam, Netherlands |
| EHG | Ethylhexylglycerin, 3-[(2- | ShinSeung Hichem Co., Ltd. |
| | Ethylhexyl)oxy]-1,2-propanedio1, | |
| | 100% | |
| Ethanol | Ethanol, 95% | Samchun Chemicals Co., Ltd. |
| HS-205 | Vinylpyrrolidone/dimethylaminoethyl | Ashland Global, Wilmington, |
| | methacrylate copolymer in 20% | DE, United States |
| | aqueous solution available under the | |
| | designation SOREZ HS-205 | |
| LT60 | Sulfate-based surfactant. | Miwon Commerical Co., Ltd., |
| | Triethanolaminedodecylbenzene | Anyang, Gyunggi-do, South |
| | sulfonate, available under the | Korea |
| | designation MICOLIN LT60 | |
| PCMX | 4-Chloro-3,5-dimethylphenol | Merck KGaA, Darmstadt, |
| | | Germany |
| PNG-20 | Vinylpyrrolidone/dimethylaminoethyl | Miwon Commerical Co., Ltd |
| | methacrylate copolymer in 20% | |
| | aqueous solution available under the | |
| | designation MIHAPOL PNG-20 | |
| S530 | Sulfate-based surfactant. Sodium | Miwon Commerical Co., Ltd |
| | lauryl sulfate solution, available under | |
| | the designation MICOLIN S530, 30% | |
| S900 | Aqueous solution of an acrylic | Solvay S.A., Brussels, Belgium |
| | copolymer, available under the | |
| | designation MIRAPOL S900, 5% | |
| SB | Sodium benzoate, 100% | Emerald Performance Materials, |
| | | Vancouver, WA, United States |
| T91-6A | Alcohol ethoxylate surfactant, | Evonik Industries, Essen, |
| | available under the designation | Germany |
| | TOMADOL 91-6, 60% | |
| T91-6B | TOMADOL 91-6, 100% | Evonik Industries, Essen, |
| | | Germany |
| WA-100 | Sulfate-based surfactant. Sodium | Stepan Company, Northfield, |
| | lauryl sulfate powder, available under | IL, United States |
| | the designation STEPANOL WA-100, | |
| | 100% | |

### Test Methods

### Surface Hydrophilicity Test:

A ceramic bathroom tile surface was cleaned using a non-scratch SCOTCH-BRITE brand scouring pad and general cleansing detergent. After drying, the tile surface was rinsed with ethanol. An initial contact angle was measured using a Kruss DSA100 contact angle tester. 2 to 3 grams of an antimicrobial composition was applied to a surface of a non-scratch 3M SCOTCH-BRITE brand pad. 30 mL of water was added to the coated non-scratch pad and the tile was scrubbed about ten times back and forth using moderate hand pressure. The tile was allowed to dry at ambient temperature for 30 seconds. The tile was rinsed with 100 mL of water for seven seconds, then allowed to completely dry at ambient temperature and contact angle was measured again. The steps of rinsing with 100 mL water, drying, and measuring contact angle were repeated 13 more times. Contact angles were recorded at each rinse, dry and measure time (indicated as a ‘cycle’) after 1, 2, 3, 5, 8, 11, and 14 cycles.

### Antimicrobial Test 1:

Materials used for antimicrobial testing are listed in Table 2.

TABLE 2
Antimicrobial Test Materials

| Material | Description | Source |
|---|---|---|
| Bacterial | Staphylococcus aureus (S. aureus) ATCC | The American Type Culture |
| cultures | 6538 | Collection (ATCC), Manassas, |
| | Escherichia coli (E. coli) ATCC 25922 | VA, United States |
| Tryptic Soy | Trypticase Soy Broth prepared according to | Becton Dickinson, Franklin |
| Broth | manufacturer's instructions, available under | Lakes, NJ, United States |
| | the designation DIFCO Tryptic Soy Broth | |
| RAC plate | 3M PETRIFILM Rapid Aerobic Count Plate | 3M Company, St. Paul, MN, |
| | | United States |
| D/E | Neutralizing Broth available under the | Becton Dickinson |
| Neutralizing | designation DIFCO DE (Dey and Engley) | |
| Broth | Neutralizing Broth | |

An in vitro, time-kill assay was used to determine the effectiveness of the antimicrobial solutions. This test shows the ability of an antimicrobial agent to reduce number of viable cells of the chosen microorganisms during a chosen contact time.

Escherichia coli (ATCC 25922) and Staphylococcus aureus (ATCC 6538) bacterial cultures were grown overnight in Tryptic Soy Broth prepared according to manufacturer's instructions at 37° C. shaking at 250 RPM. One milliliter (mL) of each culture was centrifuged for one minute at 14000 RPM in a microcentrifuge tube. The supernatant was removed, and the pellets were resuspended in 10 mL of sterile phosphate buffered saline to create bacterial suspensions.

An antimicrobial sample solution (180 microliters (μL)) was combined with the bacterial suspensions (20 μL) and pipetted up and down to achieve good mixing. After a determined timepoint, 20 μL of the mixture was transferred to 180 μL of D/E Neutralizing Broth. Neutralized samples were further serial diluted and plated onto 3M Rapid Aerobic PETRIFILM plates. After incubation, colonies were counted, and the number of surviving microorganisms expressed in colony forming units (CFU) were enumerated. A Test control was prepared by combining incubating inoculums with phosphate buffered saline (PBS) instead of the test solutions. Log reduction value was calculated as the difference between log (CFU/ml) for incubation in PBS and log (CFU/ml) for the antimicrobial test solutions.

### Antimicrobial Test 2

The methods of ASTM E2315-2016 Standard Test Method of Assessment of Antimicrobial Activity Using a Time Kill Procedure were followed. A suspension of bacteria Escherichia coli (ATCC 8739), Staphylococcus aureus (ATCC 6538), or Salmonella (ATCC 14028) was added to a volume of the test formulations and controls, and at desired time points a determined volume was pipetted into a neutralizer to stop antimicrobial activity. The neutralizer tubes were vortexed, serially diluted and plated for enumeration of surviving bacteria. Kill efficacy percent was recorded.

### Examples 1-10 (EX1-EX10) and Comparative Examples 1-3 (CE1-CE3)

Quantities of materials (in weight percent) identified in Table 3 and Table 4 were combined, and vigorously mixed for two minutes.

TABLE 3
Antimicrobial Compositions (weight percent)

| | EX1 | EX2 | EX3 | EX4 | EX5 | EX6 | EX7 | EX8 |
|---|---|---|---|---|---|---|---|---|
| Water | 38.9 | 43.9 | 48.9 | 48.9 | 48.9 | 43.9 | 47.6 | 47.2 |
| LT60 | 0.0 | 0.0 | 0.0 | 0.0 | 15.0 | 15.0 | 15.0 | 15.0 |
| S530 | 45.0 | 45.0 | 45.0 | 45.0 | 30.0 | 30.0 | 30.0 | 30.0 |
| S900 | 15.0 | 10.0 | 5.0 | 0.0 | 5.0 | 0.0 | 0.0 | 0.0 |
| PNG-20 | 0.0 | 0.0 | 0.0 | 5.0 | 0.0 | 5.0 | 5.0 | 5.0 |
| Blue Dye | 0.1 | 0.1 | 0.1 | 0.1 | 0.1 | 0.1 | 0.1 | 0.1 |
| EDTA-4Na | 0.2 | 0.2 | 0.2 | 0.2 | 0.2 | 0.2 | 0.2 | 0.2 |
| SB | 0.5 | 0.5 | 0.5 | 0.5 | 0.5 | 0.5 | 0.5 | 0.5 |
| DCDC | 0.3 | 0.3 | 0.3 | 0.3 | 0.3 | 0.3 | 0.0 | 0.0 |
| CG | 0.0 | 0.0 | 0.0 | 0.0 | 0.0 | 0.0 | 0.3 | 0.0 |
| EHG | 0.0 | 0.0 | 0.0 | 0.0 | 0.0 | 0.0 | 0.3 | 0.0 |
| CA | 0.0 | 0.0 | 0.0 | 0.0 | 0.0 | 0.0 | 1.0 | 2.0 |

TABLE 4
Antimicrobial Compositions (weight percent)

| | EX9 | EX10 | CE1 | CE2 | CE3 |
|---|---|---|---|---|---|
| Water | 75.3 | 74.3 | 62.2 | 74.3 | 75.8 |
| PNG-20 | 0.0 | 0.0 | 5.0 | 0.0 | 0.0 |
| Blue Dye | 0.0 | 0.0 | 0.1 | 0.0 | 0.0 |
| EDTA-4Na | 0.2 | 0.2 | 0.2 | 0.2 | 0.2 |
| SB | 0.5 | 0.5 | 0.5 | 0.5 | 0.0 |
| CA | 1.0 | 2.0 | 2.0 | 2.0 | 1.0 |
| T91-6A | 0.0 | 0.0 | 30.0 | 0.0 | 0.0 |
| T91-6B | 0.0 | 0.0 | 0.0 | 18.0 | 0.0 |
| HS-205 | 5.0 | 5.0 | 0.0 | 5.0 | 5.0 |
| WA-100 | 18.0 | 18.0 | 0.0 | 0.0 | 18.0 |

Surface Hydrophilicity testing was conducted, and the results are represented in Table 5.

TABLE 5
Surface Hydrophilicity Test Results

| Cycle | EX1 | EX2 | EX3 | EX4 | EX5 | EX6 | EX7 | EX8 | CE1 |
|---|---|---|---|---|---|---|---|---|---|
| 1 | 28.21 | 26.60 | 29.38 | 29.42 | 19.67 | 18.05 | 22.71 | 21.76 | 29.39 |
| 2 | 32.59 | 32.81 | 35.48 | 37.95 | 26.83 | 19.28 | 25.51 | 24.08 | 33.46 |
| 3 | 38.07 | 34.36 | 38.95 | 40.87 | 23.51 | 20.55 | 30.79 | 27.55 | 38.67 |
| 5 | 45.55 | 46.99 | 44.37 | 39.11 | 29.78 | 20.61 | 35.84 | 30.37 | 45.13 |
| 8 | NT | NT | 53.35 | 51.07 | 22.22 | 24.42 | 32.02 | 29.19 | 53.29 |
| 11 | NT | NT | NT | NT | 30.22 | 29.18 | 29.90 | 29.10 | NT |
| 14 | NT | NT | NT | NT | 31.53 | 29.84 | 32.67 | 29.42 | NT |

NT: Not Tested

### Examples 11-15 (EX11-EX15) and Comparative Examples 4-13 (CE4-CE13)

Quantities of materials (in weight percent) identified in Table 6 and Table 7 were combined, and vigorously mixed for two minutes.

TABLE 6
Antimicrobial Compositions (weight percent)

| | CE4 | CE5 | CE6 | CE7 | CE8 | CE9 | CE10 | CE11 | CE12 | CE13 |
|---|---|---|---|---|---|---|---|---|---|---|
| LT60 | 0 | 0 | 14.96 | 0 | 15.08 | 14.96 | 14.96 | 14.88 | 14.96 | 15.04 |
| WA-100 | 0 | 0 | 0 | 8.96 | 9.04 | 9.04 | 8.92 | 8.92 | 9 | 8.96 |
| BTC 888 | 0.52 | 0.52 | 0.52 | 0.52 | 0 | 0.56 | 0.6 | 0.52 | 0 | 0 |
| CA | 0 | 2 | 0 | 0 | 0 | 0 | 2 | 5 | 2.04 | 5.08 |
| PNG-20 | 0 | 0 | 0 | 0 | 4.8 | 4.88 | 4.76 | 4.92 | 4.96 | 5.2 |
| EHG | 0 | 0 | 0 | 0 | 0.32 | 0.32 | 0.32 | 0.32 | 0.32 | 0.32 |
| CG | 0 | 0 | 0 | 0 | 0.28 | 0.36 | 0.36 | 0.32 | 0.32 | 0.32 |
| SB | 0 | 0 | 0 | 0 | 0.48 | 0.48 | 0.52 | 0.52 | 0.48 | 0.52 |
| Water | 99.52 | 97.52 | 84.48 | 90.8 | 70.04 | 69.84 | 67.72 | 64.64 | 68.04 | 64.96 |

TABLE 7
Antimicrobial Compositions (weight percent)

| | EX11 | EX12 | EX13 | EX14 | EX15 |
|---|---|---|---|---|---|
| LT60 | 15 | 15 | 15 | 15 | 15 |
| WA-100 | 9 | 9 | 9 | 9 | 9 |
| CA | 2 | 2 | 1 | 1.5 | 2 |
| PNG-20 | 5 | 5 | 5 | 5 | 5 |
| EHG | 0 | 0 | 0.3 | 0.3 | 0.3 |
| CG | 0 | 0 | 0.3 | 0.3 | 0.3 |
| SB | 0 | 0.5 | 0.5 | 0.5 | 0.5 |
| EDTA-4Na | 0.2 | 0.2 | 0.2 | 0.2 | 0.2 |
| Water | 68.8 | 68.3 | 68.7 | 68.2 | 67.7 |

Antimicrobial Test 1 was conducted, and the results are represented in Table 8.

TABLE 8
Antimicrobial Test 1 Results

| | S. aureus | E. coli |
|---|---|---|
| EX11 | 5.17 | 5.45 |
| EX12 | 5.17 | 5.49 |
| EX13 | 5.17 | 5.27 |
| EX14 | 5.17 | 5.29 |
| EX15 | 5.17 | 5.96 |
| CE4 | 6.02 | NT |
| CE5 | 6.02 | NT |
| CE6 | 0.63 | NT |
| CE7 | 0.7 | NT |
| CE8 | 4.39 | 0.95 |
| CE9 | 4.3 | 0.66 |
| CE10 | 6.02 | 4.84 |
| CE11 | 6.02 | 6.39 |
| CE12 | 6.02 | 5.08 |
| CE13 | 6.02 | 6.06 |

NT: Not Tested

Antimicrobial Test 2 was conducted, and the results are represented in Table 9.

TABLE 9
Antimicrobial Test 2 Results

| | EX7 | EX8 |
|---|---|---|
| pH | 4.5 | 3.3 |
| Contact Time | 20 min | 5 min |
| E. coli | 99.99% | 99.99% |
| S. aureus | 99.99% | 99.99% |
| Salmonella | 99.99% | 99.99% |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. An antimicrobial cleaning composition comprising:
an anionic surfactant, optionally comprising a sulfate-based surfactant, sulfonate-based surfactant, or combination thereof;
sodium benzoate;
optionally at least one of caprylyl glycol and ethylhexylglycerin;
an acrylic-based copolymer;
an organic acid, optionally comprising citric acid; and
ethylenediaminetetraacetic acid.

2. The composition of claim 1, wherein the composition comprises at least one of caprylyl glycol and ethylhexylglycerin.

3. The composition of claim 1, wherein the acrylic-based copolymer comprises a copolymer of vinyl pyrrodine and dimethylaminoethyl methacrylate.

4. The composition of claim 1, wherein the anionic surfactant is present in an amount of from 3 percent to 30 percent by weight, based on the overall weight of the composition.

5. The composition of claim 1, wherein the anionic surfactant comprises one or more of sodium lauryl sulfate, sodium laureth sulfate, ammonium lauryl sulfate, and ammonium laureth sulfate.

6. The composition of claim 1, wherein the anionic surfactant is sulfate-based and further comprising an anionic surfactant that is not sulfate-based.

7. The composition of claim 6, wherein the anionic surfactant that is not sulfate-based comprises triethanolamine dodecylbenzene sulfonate.

8. The composition of claim 7, the wherein the triethanolamine dodecylbenzene sulfonate is present in an amount of from 3 percent to 24 percent by weight, based on the overall weight of the composition.

9. The composition of claim 1, wherein the composition comprises both caprylyl glycol and ethylhexylglycerin.

10. The composition of claim 1, the wherein the caprylyl glycol is present in an amount of from 0.1 percent to 10 percent by weight, based on the overall weight of the composition.

11. The composition of claim 1, the wherein the ethylhexylglycerin is present in an amount of from 0.1 percent to 10 percent by weight, based on the overall weight of the composition.

12. The composition of claim 1, wherein the acrylic-based copolymer is present in an amount of from 1 percent to 25 percent by weight, based on the overall weight of the composition.

13. The composition of claim 1, wherein citric acid is present in an amount of from 0.1 percent to 10 percent by weight, based on the overall weight of the composition.

14. The composition of claim 1, further comprising water.

15. The composition of claim 14, the wherein the water is present in an amount of from 70 percent to 80 percent by weight, based on the overall weight of the composition.

16. The composition of any one of claim 1, wherein the composition is substantially free of siloxane components.

17. A cleaning article comprising the composition of claim 1 disposed on a cleaning substrate.

18. The cleaning article of claim 17, wherein the cleaning substrate comprises a fibrous non-woven web.

19. The cleaning article of claim 18, wherein the fibrous non-woven web is coated with the composition in an amount of from 10 percent to 25 percent by weight, relative to the overall weight of the coated fibrous non-woven web.

20. A method of cleaning a surface comprising the steps of:
applying the composition of claim 1 onto a cleaning substrate;
wiping the cleaning substrate along the surface.
